(19) United States
(12) Patent Application Publication
(10) Pub. No.: US 2025/0057195 A1
(43) Pub. Date: Feb. 20, 2025

(54) BREAD CRUMBS COMPOSITION

(71) Applicant: Asaf Cohen-Jonathan, Nahariya (IL)

(72) Inventor: Asaf Cohen-Jonathan, Nahariya (IL)

(21) Appl. No.: 18/235,403

(22) Filed: Aug. 18, 2023

(51) Int. Cl. A23L 7/157; A23J 3/14

(52) U.S. Cl. CPC A23L 7/157; A23J 3/14

(57) ABSTRACT

A unique bread crumb composition is disclosed. The bread crumb composition is derived from a dough. The dough is added with a protein content. The protein content is maize protein. The derived bread crumbs composition comprises a source of protein content that ranges from about 20% to about 50%. The protein-derived bread crumb absorbs about 25%-50% less fat to reduce calories. The bread crumb composition is prepared from various other proteins with different absorption rates. Further, a method is used to prepare the bread crumb composition from a dough added with a protein content of about 20-80%.

### TECHNICAL FIELD

The present invention generally relates to bread crumbs. More specifically, the present invention relates to a protein mixture for preparing a unique bread crumbs composition.

### BACKGROUND

Bread crumbs are crumbled bread particles that are used in a variety of food products. Bread crumbs are made with various dryness, sometimes with seasonings added, used for breading or crumbing foods, topping casseroles, stuffing poultry, thickening stews, adding inexpensive bulk to soups, meatloaves and similar foods, and making a crisp and crunchy covering for fried foods. Breading of a dry grain-derived food coating made from bread crumbs or a breading mixture with seasonings is provided for a piece of food product. Breading is well suited for frying as it lends itself to creating a crisp coating around the food.

The food product coated with bread crumbs are typically pre-fried and provided frozen for consumers to conveniently cook at home. These food products are usually manufactured on a mass scale, with the core of the food product, such as fish or chicken efficiently coated using industrial production lines.

Consumers are looking for coated-food products that have a unique texture, taste, or visual appeal compared with traditional-coated products. Consumers expect a stable coat on a coated food product such that the coat remains intact during cooking at home. In addition, there is increasing concern that traditional-coated products are “unhealthy”. Therefore, there is a need for novel and unique coated products comprising healthier ingredients that provide the consumer with a distinctive textural experience, and an interesting and appealing appearance.

Thus, there is a need for a novel and unique bread crumbs composition having healthier ingredients. Also, there is a need for bread crumbs composition to have less fat and calories.

### SUMMARY

The present invention generally discloses bread crumbs. Further, the present invention discloses a mixture of dough and protein content for preparing bread crumbs composition.

According to the present invention, a novel bread crumb composition is disclosed. In one embodiment, the bread crumb composition is a unique and healthy food coating composition that has been prepared to apply on a food substrate. In one embodiment, the bread crumb composition is derived from a dough. In an exemplary embodiment, the dough is added with a protein content. The protein mixed dough is used to prepare the bread crumb composition. In one embodiment, the bread crumb composition is derived from the dough with protein content, thereby absorbing less fat than regular breadcrumbs and reducing calories. For example, the bread crumb composition absorbs about 10%-90% less fat than regular breadcrumbs to reduce calories in the product.

In one embodiment, the bread crumb composition comprises the protein content ranges from about 20% to about 80%. In some embodiments, the protein content is in the form of a concentrated liquid, a paste, a powder, or a granulate. In one embodiment, the bread crumb composition comprises any of maize protein, gluten protein, legumes protein, or other suitable protein sources. In an exemplary embodiment, the protein content is maize protein (zein or corn mill). Further, the bread crumb composition comprises a source of maize protein. In one embodiment, the bread crumb composition comprises the source of maize protein ranging from about 20% to about 50%. In some embodiments, the bread crumb composition may be prepared from various other proteins with different absorption rates.

In one embodiment, the bread crumbs composition can be used as an animal food source. In another embodiment, the bread crumbs composition can also be used in the baking industry. The bread crumbs composition is used in the food industry to coat and polish chocolate-coated sweets.

In one embodiment, the present invention utilizes a method for preparing a bread crumb composition. The method processes a dough added with a protein content to prepare the bread crumb composition. In one embodiment, the protein content is maize protein. In one embodiment, the method uses the dough with the protein content in the range of about 20% to about 80%.

In one embodiment, the method comprises the following steps. At one step, the dough is prepared by mixing one or more ingredients. The ingredients include, but not limited to, flour, water, yeast, and sugar. At another step, the protein content is added to the dough. In an exemplary embodiment, the protein content is maize protein. In some embodiments, the protein content may be gluten protein, legumes protein, or other suitable protein sources. At another step, the mixture of dough and protein content is subjected to a heat conditioning step to obtain a heat conditioned bread product. At another step, the heat conditioned bread product is processed to form the bread crumb composition.

The above summary contains simplifications, generalizations, and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 shows a flowchart of a method for preparing a bread crumbs composition, according to one embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

According to the present invention, a novel bread crumb composition is disclosed. In one embodiment, the bread crumb composition is a unique and healthy food coating composition that has been prepared to apply on a food substrate. The bread crumb composition comprises bread crumbs. In one embodiment, the bread crumb composition is derived from a dough. In an exemplary embodiment, the dough is added with a protein content. The protein mixed dough is used to prepare the bread crumb composition. In one embodiment, the bread crumb composition is derived from the dough with protein content, thereby absorbing less fat than regular breadcrumbs and reducing calories. For example, the bread crumb composition absorbs about 10%-90% less fat than regular breadcrumbs to reduce calories in the product.

In one embodiment, the bread crumb composition comprises the protein content ranges from about 20% to about 80%. In some embodiments, the protein content is in the form of a concentrated liquid, a paste, a powder, or a granulate. In one embodiment, the bread crumb composition comprises any of maize protein, gluten protein, legumes protein, corn gluten meal, maize gluten, or other suitable protein sources. The corn gluten meal, maize protein, and maize gluten are all by-products derived from corn (maize), and they are often used as sources of plant-based protein in animal feed and in some food products.

Corn gluten meal is a byproduct of the corn wet-milling process. The wet-milling process involves separating the different components of the corn kernel for various uses. Corn gluten meal is primarily composed of protein and is commonly used as an animal feed ingredient due to its high protein content and amino acid profile. Maize protein is isolated from the maize grain. It can be produced through various methods, such as wet milling or dry fractionation. Maize protein can be further processed into different products, such as Zein, which is a type of protein that is highly abundant in maize. Maize protein is often used in various applications, including as a coating for drugs and supplements. Maize gluten is the water-insoluble protein fraction that remains after the wet-milling process. Maize gluten is typically used as a source of protein in animal feed. Maize gluten is often higher in protein content than Corn gluten meal and has a different amino acid profile, which makes it a valuable ingredient in animal feed formulations.

In an exemplary embodiment, the protein content is maize protein (zein or corn mill). Further, the bread crumb composition comprises a source of maize protein. In one embodiment, the bread crumb composition comprises the source of maize protein ranging from about 20% to about 50%. The maize protein is difficult to work with and normally sells as animal feed source or use in very specific way in food industry to coat and polish chocolate coated sweets. The ability to use maize protein for other uses is unique, since chemically it is very hard to handle it. In some embodiments, the bread crumb composition may be prepared from various other proteins with different absorption rates.

In one embodiment, the bread crumbs are maize protein bread crumbs. The protein mixed bread crumb composition maintains a crunchy texture and firmness that are maintained comparing to conventional bread crumbs. In one embodiment, the bread crumbs composition can be used as an animal food source. In another embodiment, the bread crumbs composition can also be used in the baking industry. The bread crumbs composition is used in the food industry to coat and polish chocolate-coated sweets.

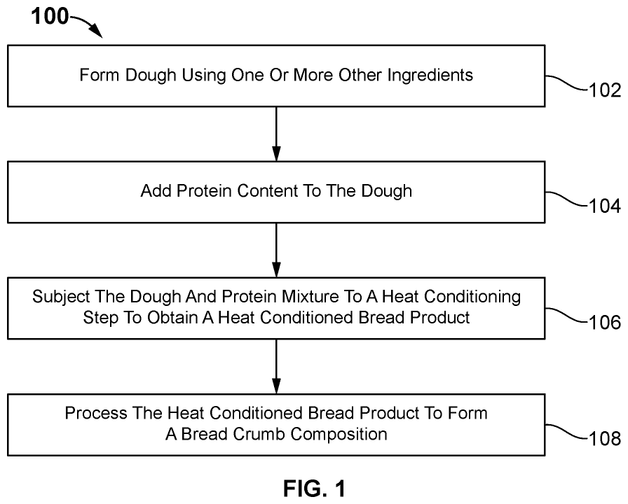

Referring to FIG. 1, a flowchart of a method 100 for preparing a bread crumbs composition is illustrated. The method 100 processes a dough added with a protein content to prepare the bread crumb composition. In one embodiment, the protein content is maize protein. In one embodiment, the method uses dough with the protein content in the range of about 20% to about 80%.

In one embodiment, the method 100 comprises the following steps. At step 102, the dough is prepared by mixing one or more ingredients. The ingredients include, but not limited to, flour, water, yeast, and sugar. At step 104, the protein content is added to the dough. In an exemplary embodiment, the protein content is maize protein. In some embodiments, the protein content may be gluten protein, legumes protein, or other suitable protein sources. At step 106, the mixture of dough and protein content is subjected to a heat conditioning step to obtain a heat conditioned bread product. At step 108, the heat conditioned bread product is processed to form the bread crumbs composition.

Further, the bread crumbs composition is mixed with one or more other ingredients. The other ingredients include, but not limited to, seasonings, spices, and herbs. The bread crumb composition is mixed to the other ingredients in a large bowl or mixer. This ensures that the bread crumb composition is evenly coated with any seasonings or spices, and that they are well-combined. The bread crumb composition is then spread out on a large tray or baking sheet, and left to dry in a low-heat oven or dehydrator. This helps to remove any excess moisture and ensure that the bread crumb composition is crisp and dry. The drying process may take anywhere from about 30 minutes to several hours.

Once the bread crumb composition dries, they are typically ground or processed into a finer texture, depending on the desired consistency. Finally, the breadcrumbs are typically packaged in airtight containers or bags to ensure that they stay fresh and dry. Depending on the type of breadcrumb being produced, there may be additional steps involved in the production process, such as toasting the bread before processing it into crumbs, or adding additional ingredients such as cheese or nuts.

Advantageously, the bread crumb composition of the present invention includes maize protein or zein or corn mill. The maize protein is usually selling as animal feed source. The maize protein is also used in the food industry. The value of the maize protein is increased by selling about 20%-50% breadcrumbs maize protein content to the baking industry. Further, the maize protein solves the problem of the current use of corn mills for animal feed by extending its current minimal use in the food industry.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A bread crumb composition for applying to a food substrate, wherein the bread crumb is derived from a dough added with a protein content, thereby absorbing less fat to reduce calories in the bread crumb composition.

2. The bread crumb composition of claim 1, wherein the protein content ranges from about 20% to about 80%.

3. The bread crumb composition of claim 1, wherein the protein content is in the form of a concentrated liquid, a paste, a powder, or a granulate.

4. The bread crumb composition of claim 1, wherein the protein content is maize protein.

5. The bread crumb composition of claim 1, comprises a source of maize protein ranging from about 20% to about 50%.

6. The bread crumb composition of claim 1, is prepared from any of gluten, legumes protein, or other suitable protein sources.

7. The bread crumb composition of claim 1, is prepared from various proteins with different absorption rates.

8. A method of preparing a bread crumb composition according to claim 1, wherein the bread crumb composition is prepared from a dough added with a protein content ranges from about 20% to about 50%.
